(19) United States
(12) Patent Application Publication
(10) Pub. No.: US 2009/0212897 A1
(43) Pub. Date: Aug. 27, 2009

(54) LOW VOLTAGE COIL AND TRANSFORMER

(75) Inventors: Stephane SCHAAL, Sierentz (FR); Patricia GONZALEZ, Zaragoza (ES); Francisco ARAUZO, Zaragoza (ES)

Correspondence Address: BUCHANAN, INGERSOLL & ROONEY PC, POST OFFICE BOX 1404, ALEXANDRIA, VA, 22313-1404, US

(73) Assignee: ABB RESEARCH LTD, Zurich (CH)

(21) Appl. No.: 12/421,659

(22) Filed: Apr. 10, 2009

Related U.S. Application Data
(63) Continuation of application No. PCT/CH2006/000582, filed on Oct. 19, 2006.

(51) Int. Cl. H01F 27/28

(52) U.S. Cl. 336/222

(57) ABSTRACT

To improve its fire resistance, the winding of a low voltage coil for a dry transformer is, at its circumferential surface, covered by a wrap made up of four turns of a protective foil comprising a layer consisting of woven glass fibers impregnated with silicone resin with an admixture of mica. An inner part winding and an outer part winding are separated by a gap comprising twelve rectangular aluminium tubes as spacers. At a lower end, the end face of the winding is covered with a protective cover comprising epoxy resin.

### RELATED APPLICATION

This application claims priority as a continuation application under 35 U.S.C. §120 to PCT/CH2006/000582 filed as an International Application on Oct. 19, 2006 designating the U.S., the entire content of which is hereby incorporated by reference in its entirety.

### TECHNICAL FIELD

The disclosure relates to a low voltage coil for a transformer as well as a dry type transformer comprising such low voltage coil, as used for power distribution in a range of 50 kVA to 25'000 kVA.

### BACKGROUND INFORMATION

WO 03/107 364 A1 discloses a coil resin-encapsulated and having spacer means based on a plurality of tubes made from a thermoplastic material and distributed over the entire cross section of the coil.

### SUMMARY

Exemplary embodiments disclosed herein can improve the known coil of generic type with respect to its fire resistance without impairing its mechanical properties.

A low voltage coil for a transformer is disclosed, with a winding made from a conductive foil and an insulating foil forming a plurality of turns where two subsequent turns of conductive foil are in each case separated by at least one turn of insulating foil, wherein the circumferential surface of the winding is at least partially covered by a fire resistant protective layer.

In another aspect, a dry type transformer is disclosed, comprising: a low voltage coil having a winding made from a conductive foil and an insulating foil forming a plurality of turns where two subsequent turns of conductive foil are in each case separated by at least one turn of insulating foil; a core with at least one leg surrounded by the said low voltage coil; and a high voltage coil surrounding the said at least one leg and said low voltage coil.

### BRIEF DESCRIPTION OF THE DRAWINGS

The disclosure is explained with reference to the following figures which show an exemplary embodiment.

FIG. 1 shows part of a cross section through a low voltage coil according to an exemplary embodiment of the disclosure,

FIG. 2 shows a radial section through an end portion of the low voltage coil of FIG. 1, along II-II, and

FIG. 3 shows a radial section similar to FIG. 2, along III-III in FIG. 1.

### DETAILED DESCRIPTION

It has been found that the exemplary embodiments according to the disclosure can significantly improve the fire resistance of a dry type transformer. Temperatures reached during a standard test were significantly lower and the time to self-extinguish was shortened by more than half. Mechanical properties were essentially equal to those of known generic type low voltage coils.

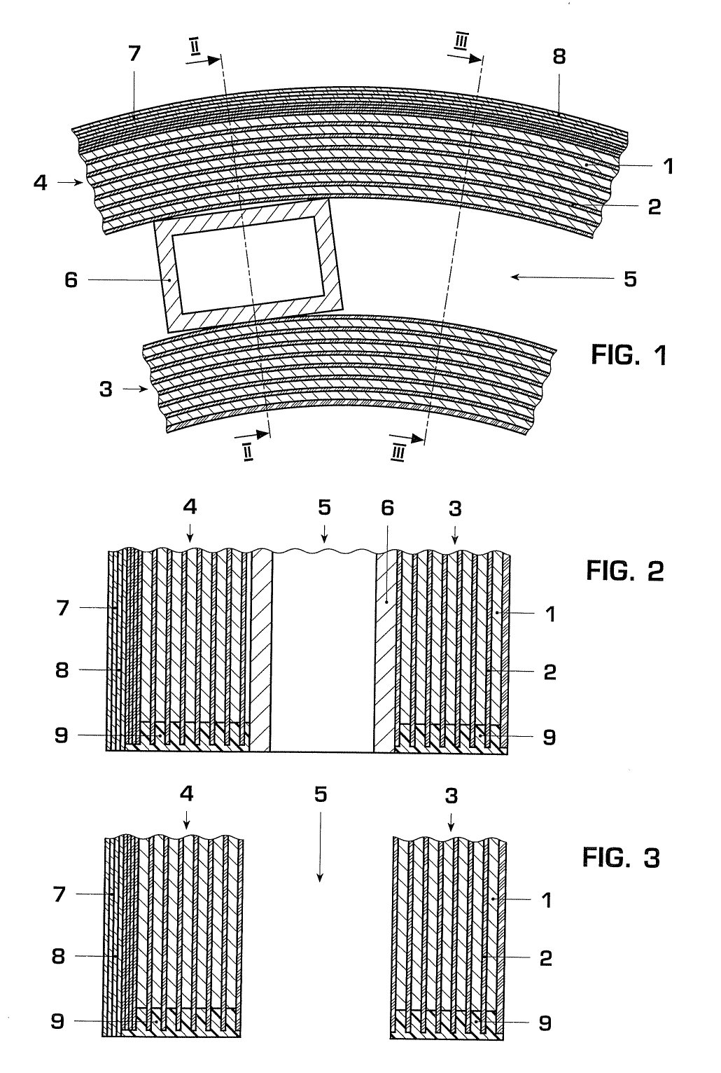

FIG. 1 shows a cross section through a low voltage coil according to an exemplary embodiment of the disclosure. The low voltage coil comprises a single winding essentially axially symmetric with respect to a vertical axis and made from a conductive foil 1 and an insulating foil 2 in such a way that two subsequent turns of conductive foil are separated by a turn of insulating foil. The conductive foil 1 may comprise aluminium and/or copper. A first lead-out of the low voltage coil is connected to its inner end margin and a second lead-out to its outer end margin (not shown). The insulating foil 2 may comprise a polymer, e.g., polyimide, polyester, polyamide and/or a mixture of polymers and/or aramide paper and/or some other material known to be adequate by those skilled in the art. It may comprise several layers each comprising such material. DMD (laminate of Dacron, Mylar, Dacron), NMN (laminate of Nomex, Mylar, Nomex), TMT (laminate of (tufQuin, Mylar, TufQuin), Nomex, Mylar and Kapton have been found to be particularly suitable. The insulating foil 2 is broader than the conductive foil 1 by about 30 mm so as to extend beyond the lateral margins of the latter.

The continuous winding comprises an inner part winding 3 and a coaxial outer part winding 4 separated by a gap 5 which completely surrounds the inner part winding 3. The gap 5 is established by spacer means which comprises twelve individual spacers 6 in the shape of straight aluminium tubes of rectangular cross section which are distributed over the circumferential surface of the inner part winding 3, each of them being arranged parallel to the axis of the winding. In an exemplary embodiment, the spacers extend over the whole length of the coil. Of course, there can be more or less spacers than indicated, e.g., between ten and thirty and they may differ in cross section and other properties from the ones described. For instance, they can be profiles, in particular, U-profiles or T-profiles. Any material with adequate mechanical properties can be used, however, inorganic materials which are fire resistant are preferred, in particular aluminium, steel and/or some other metal and/or alloy and/or even ceramic and/or glass as the use of such materials has been found to have a positive effect on the fire resistance properties of the low voltage coil. Instead of individual spacers other spacer means may be employed, e.g., a corrugated metal sheet, in particular, an aluminium sheet with creases parallel to the axis. There may also be several gaps, subdividing the low voltage coils into three or more coaxial part windings. On the other hand, there may also be no gap at all. At the upper end of the low voltage coil the inner part winding 3 and the outer part winding 4 are filled with DMD saturated laminate.

The circumferential surface of outer part winding 4 is surrounded by several turns of the insulating foil 2 and at least partially by a fire resistant layer, in particular a wrap 7 which comprises several, in particular, four, turns of an insulating non-combustible protective foil 8. The protective foil 8 preferably comprises a layer of woven glass fibers impregnated with silicon resin, preferably with an admixture of mica. Such foils are also known as mica paper and are available from various sources. Cablosam® foils, e.g., Cablosam® 366.21-10, DURAPOL FR-HA 2, RAL 7001 and S 2000 E available from VonRoll Isola and CABLEFLEX 1/2A and 2/2 from jsi have been found to be suitable. However, other materials may be used as well as long as they have the required fire resistance and mechanical properties. In particular, the material has to be non-combustible and electrically insulating and be suitable for partially or completely covering the circumferential surface of the winding.

FIG. 2 shows a radial section through an end portion of the low voltage coil of FIG. 1, along the cut II-II, and FIG. 3 shows a radial section similar to FIG. 2, along the cut III-III in FIG. 1. In these figures it is shown that at the lower end the low voltage coil is sealed by a protective cover 9 which extends at least partially or, in an exemplary embodiment completely, over the bottom end face, of the inner winding 3 and the outer winding 4 and into their lower parts while leaving out the gap 5 in order to allow air circulation for cooling and which comprises epoxy resin, e.g., EPR M4-1291-SP with EPH 105 added as a hardener as available from Hexion. The upper end of the low voltage coil is sealed in the same way.

The low voltage coil is produced in the manner described below:

A winding machine is loaded with rolls of conductive foil 1 and insulating foil 2 and a narrower roll of DMD saturated laminate. The first lead-out is attached to the conductive foil by tungsten inert gas welding. Then the inner part winding 3 of the low voltage coil is wound and its upper part filled with the DMD saturated laminate wound up together with the conductive foil 1 and the insulating foil 2. After that the spacers 6 are put into place. The winding process is then continued and the outer part winding 4 applied in the same way as the inner part winding 3 before. The second lead-out is then attached to the conductive foil, again by tungsten inert gas welding. Now, the wrap 7 is applied to the circumferential surface of the outer part winding 4 by winding four turns of protective foil 8 on it. Finally, to apply the protective cover 9 the lower part of the low voltage coil is sealed with a liquid mass comprising epoxy resin and, finally, the low voltage coil is cured in an oven for 2 h at 120° C.

The low voltage coil as described and a reference coil without a wrap and a protective layer and with polyester-filled glass fiber spacers were subjected to fire tests according to the IEC 60076-11 standard. In each case, a fire was lighted with 7.7 I of alcohol and the temperature above the fire was measured as prescribed by the said standard.

The results were as follows:

| | temperature in ° C. | temperature in ° C. | time in min to |
|---|---|---|---|
| | after 45 min | after 60 min | self-extinguish |
| reference | 206.7 | 165.3 | 157 |
| embodiment | 86.9 | 59.8 | 62 |

Obviously, the fire resistance properties of the low voltage coil according to the above-described exemplary embodiment of the disclosure shows a very significant improvement over the respective properties of the conventional reference coil.

The disclosure also relates to a transformer comprising at least one inventive low voltage coil. The transformer may otherwise be of known construction, e.g., as shown in WO 00/31 761 A1, with a core with three legs connected by an upper yoke and a lower yoke, each leg being surrounded by a low voltage coil and a high voltage coil surrounding the leg and the low voltage coil. Such dry type transformers are employed in particular as distribution transformers for a power range of between 50 kVA and 25'000 kVA.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 conductive foil
2 insulating foil
3 inner part winding
4 outer part winding
5 gap
6 spacer
7 wrap
8 protective foil
9 protective cover

What is claimed is:

1. A low voltage coil for a transformer, with a winding made from a conductive foil and an insulating foil forming a plurality of turns where two subsequent turns of conductive foil are in each case separated by at least one turn of insulating foil, wherein the circumferential surface of the winding is at least partially covered by a fire resistant protective layer.

2. The low voltage coil according to claim 1, wherein the protective layer comprises an electrically insulating non-combustible material.

3. The low voltage coil according to claim 1, wherein the protective layer is in the shape of a wrap comprising at least one turn of a protective foil with a layer comprising glass fibers impregnated with silicone resin, preferably with an admixture of mica.

4. The low voltage coil according to claim 3, wherein the number of turns of protective foil is between two and six and preferably equals four.

5. The low voltage coil according to claim 1, wherein the low voltage coil comprises at least one spacer means inserted between subsequent turns, in particular extending over the length of the winding in an axial direction, and which spacer means separates an inner part winding from a subsequent part winding by a gap surrounding the said inner part winding.

6. The low voltage coil according to claim 5, wherein the at least one spacer means comprises several spacers, which are arranged parallel to each other in winding direction, each spacer in particular extending over the length of the coil in the axial direction.

7. The low voltage coil according to claim 6, wherein the each of the spacers is either in the shape of a tube or of a profile, in particular, a U-profile or T-profile.

8. The low voltage coil according to claim 5, wherein the at least one spacer means comprises a corrugated sheet, the corrugated sheet in particular extending over the length of the coil in the axial direction, with creases parallel to the axial direction.

9. The low voltage coil according to claim 5, wherein the spacer means comprises inorganic material, in particular metal, e.g., aluminium or steel, and/or ceramic and/or glass.

10. The low voltage coil according to claim 1, wherein the winding is at least partially sealed at one end by a protective cover of epoxy resin at least partially extending over an end face of winding.

11. A dry type transformer comprising the low voltage coil according to claim 1, with a core with at least one leg surrounded by the said low voltage coil and a high voltage coil surrounding the said at least one leg and the said low voltage coil.

12. The low voltage coil according to claim 2, wherein the protective layer is in the shape of a wrap comprising at least one turn of a protective foil with a layer comprising glass fibers impregnated with silicone resin, preferably with an admixture of mica.

13. The low voltage coil according to claim 3, wherein the low voltage coil comprises at least one spacer means inserted between subsequent turns, in particular extending over the length of the winding in an axial direction, and which spacer means separates an inner part winding from a subsequent part winding by a gap surrounding the said inner part winding.

14. The low voltage coil according to claim 8, wherein the spacer means comprises inorganic material, in particular metal, e.g., aluminium or steel, and/or ceramic and/or glass.

15. The low voltage coil according to claim 5, wherein the winding is at least partially sealed at one end by a protective cover of epoxy resin at least partially extending over an end face of winding.

16. A dry type transformer comprising:
a low voltage coil having a winding made from a conductive foil and an insulating foil forming a plurality of turns where two subsequent turns of conductive foil are in each case separated by at least one turn of insulating foil;
a core with at least one leg surrounded by the said low voltage coil; and
a high voltage coil surrounding the said at least one leg and said low voltage coil.

17. The dry type transformer according to claim 16, wherein a circumferential surface of the winding is at least partially covered by a fire resistant protective layer.

18. A dry type transformer comprising the low voltage coil according to claim 5, with a core with at least one leg surrounded by the said low voltage coil and a high voltage coil surrounding the said at least one leg and the said low voltage coil.
